(19) United States
(12) Patent Application Publication
(10) Pub. No.: US 2026/0237016 A1
(43) Pub. Date: Aug. 13, 2026

(54) Prediction-based Data Cache Management for Ray Tracing

(71) Applicant: Apple Inc., Cupertino, CA (US)

(72) Inventors: David J. Bermingham, Cambridge (GB); Fergus W. MacGarry, Cambridge (GB)

(21) Appl. No.: 19/051,760

(22) Filed: Feb. 12, 2025

(51) Int. Cl. G06T 1/60; G06T 15/06

(52) U.S. Cl. CPC G06T 1/60; G06T 15/06

(57) ABSTRACT

Techniques are disclosed relating to maintaining a data cache for ray test circuitry using re-use prediction. The cache may be set associative. Circuitry may maintain, for cache lines of the data cache, respective prediction values that predict likelihood of future re-use, including modifying prediction values of other cache lines in a first set in response to the allocation of a cache line in the set and modify the prediction value of the cache line based on a hit to the cache line. The prediction values may be used to determine victim cache line(s). Control circuitry may assign an initial prediction value to the cache line based on characteristics of data stored by the cache line (e.g., level in a bounding volume hierarchy, size of a bounding volume, characteristics of primitives inside a bounding volume, ray characteristics, tracking ray traversal paths, etc.).

### BACKGROUND

### Technical Field

This disclosure relates generally to graphics processors and more particularly to caching data for ray tracing operations.

### Description of Related Art

In computer graphics, ray tracing is a rendering technique for generating an image by tracing the path of light as pixels in an image plane and simulating the effects of its encounters with virtual objects. Ray tracing may allow resolution of visibility in three dimensions between any two points in the scene, which is also the source of most of its computational expense. A typical ray tracer samples paths of light through the scene in the reverse direction of light propagation, starting from the camera and propagating into the scene, rather than from the light sources (this is sometimes referred to as “backward ray tracing”). Starting from the camera has the benefit of only tracing rays which are visible to the camera. This system can model a rasterizer, in which rays simply stop at the first surface and invoke a shader (analogous to a fragment shader) to compute a color. More commonly, secondary effects-in which the exchange of illumination between scene elements, such as diffuse inter-reflection and transmission-are also modelled. Shaders that evaluate surface reflective properties may invoke further intersection queries (e.g., generate new rays) to capture incoming illumination from other surfaces. This recursive process has many formulations but is commonly referred to as path tracing.

Graphics processors that implement ray tracing typically provide more realistic scenes and lighting effects, relative to traditional rasterization systems. Ray tracing is typically computationally expensive, however. Certain ray tracing operations may be accelerated using specialized hardware. This hardware may utilize data caches to store various data associated with ray tracing, e.g., node data from a bounding volume hierarchy (BVH) acceleration data structure (ADS). There may be important tradeoffs between cache performance and size, in this context, so efficient cache management may have substantial impacts on design targets.

Improvements to ray tracing techniques may improve realism in graphics scenes (e.g., increasing the number of rays traced per frame or allowing ray tracing in more complex scenes), improve performance (e.g., increased frames per second), reduce power consumption (which may be particularly important in battery-powered devices), or some combination thereof.

### BRIEF DESCRIPTION OF DRAWINGS

FIG. 1A is a diagram illustrating an overview of example graphics processing operations, according to some embodiments.

FIG. 1B is a block diagram illustrating an example graphics unit, according to some embodiments.

FIG. 2 is a block diagram illustrating example cache control circuitry with prediction values for a data cache, according to some embodiments.

FIG. 3 is a block diagram illustrating example prediction update circuitry and victim selection circuitry, according to some embodiments.

FIG. 4 is a block diagram illustrating example victim selection logic for multiple victims that uses a long vector and a one-hot victim encoding, according to some embodiments.

FIG. 5 is a block diagram illustrating example victim selection logic for a single victim that uses find-first operations among portions of the long vector, according to some embodiments.

FIG. 6 is a diagram illustrating an example BVH tree, according to some embodiments.

FIG. 7 is a block diagram illustrating example prediction update control circuitry that operates based characteristics of cached data, according to some embodiments.

FIG. 8 is a block diagram illustrating example prediction update control circuitry with ray characteristic and path tracking for dynamic predictions, according to some embodiments.

FIG. 9 is a block diagram illustrating a detailed example of circuitry for ray characteristic and path tracking, according to some embodiments.

FIG. 10 is a flow diagram illustrating an example method, according to some embodiments.

FIG. 11 is a block diagram illustrating an example computing device, according to some embodiments.

FIG. 12 is a diagram illustrating example applications of disclosed systems and devices, according to some embodiments.

FIG. 13 is a block diagram illustrating an example computer-readable medium that stores circuit design information, according to some embodiments.

### DETAILED DESCRIPTION

A graphics processor may include hardware accelerator circuitry for ray tracing operations such as node intersection tests for acceleration data structure traversal, primitive tests, or both. The acceleration hardware may cache data from the acceleration data structure (e.g., node data from a bounding volume hierarchy) to provide fast and energy-efficient access when the data is re-used or prefetched. Generally, improving the efficiency of such caches (e.g., improving hit rate by increasing retention of information that will be re-used and eviction of information that will not be re-used) may advantageously improve graphics performance, reduce power consumption, or both.

In disclosed embodiments, prediction techniques are used to determine which cache lines to retain/evict for a data cache that stores data for a ray tracing acceleration data structure. For example, each cache line may be assigned a re-reference prediction value (RRPV) in a re-reference prediction interval (RRPI) scheme. Disclosed prediction techniques may improve cache efficiency relative to traditional techniques such as least-recently-used (LRU) or pseudo-LRU techniques. Further, disclosed prediction techniques may be highly scalable.

The present disclosure also provides efficient logic for selecting victim cache lines, including separate example implementations for multi-victim and single-victim selection. The present disclosure also provides static and dynamic prediction techniques, e.g., for selecting initial RRPVs based on: characteristics of data being cached, characteristics of rays being processed, tracked paths through the acceleration data structure, or some combination thereof.

### Graphics Processing Overview

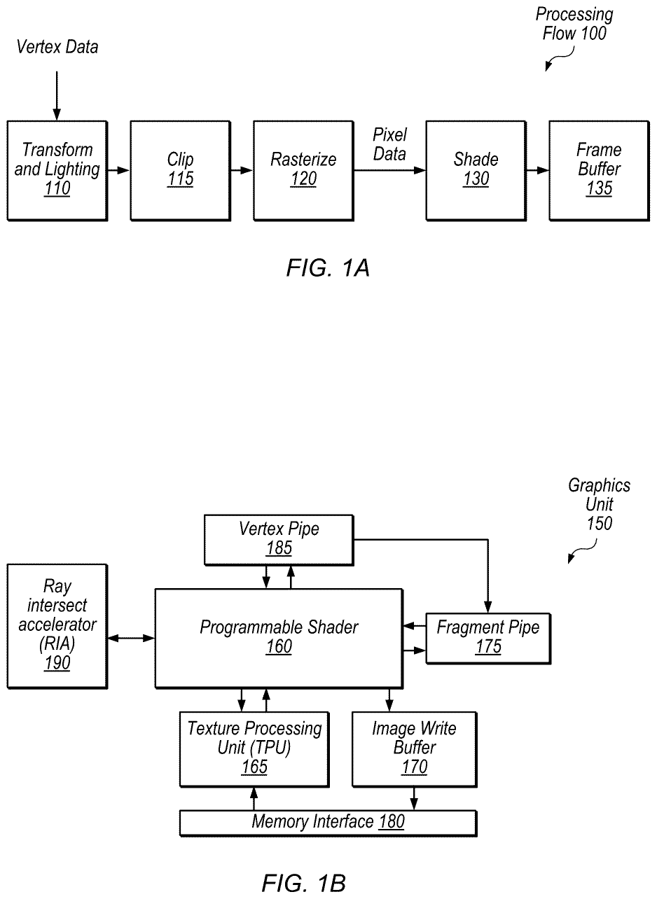

Referring to FIG. 1A, a flow diagram illustrating an example processing flow 100 for processing graphics data is shown. In some embodiments, transform and lighting procedure 110 may involve processing lighting information for vertices received from an application based on defined light source locations, reflectance, etc., assembling the vertices into polygons (e.g., triangles), and transforming the polygons to the correct size and orientation based on position in a three-dimensional space. Clip procedure 115 may involve discarding polygons or vertices that fall outside of a viewable area. In some embodiments, geometry processing may utilize object shaders and mesh shaders for flexibility and efficient processing prior to rasterization. Rasterize procedure 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer), ignoring one or more fragments (e.g., if they are covered by other objects), or both. Shade procedure 130 may involve altering pixel components based on lighting, shadows, bump mapping, translucency, etc. Shaded pixels may be assembled in a frame buffer 135. Modern GPUs typically include programmable shaders that allow customization of shading and other processing procedures by application developers. Thus, in various embodiments, the example elements of FIG. 1A may be performed in various orders, performed in parallel, or omitted. Additional processing procedures may also be implemented.

Referring now to FIG. 1B, a simplified block diagram illustrating a graphics unit 150 is shown, according to some embodiments. In the illustrated embodiment, graphics unit 150 includes programmable shader 160, vertex pipe 185, fragment pipe 175, texture processing unit (TPU) 165, image write buffer 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 or programmable shader 160 to generate fragment data. Vertex pipe 185 and fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and TPU 165. Programmable shader 160 may be configured to perform vertex processing tasks on vertex data which may include various transformations and adjustments of vertex data. Programmable shader 160, in the illustrated embodiment, is also configured to perform fragment processing tasks on pixel data such as texturing and shading, for example. Programmable shader 160 may include multiple sets of multiple execution pipelines for processing data in parallel.

In some embodiments, programmable shader includes pipelines configured to execute one or more different SIMD groups in parallel. Each pipeline may include various stages configured to perform operations in a given clock cycle, such as fetch, decode, issue, execute, etc. The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

The term “SIMD group” is intended to be interpreted according to its well-understood meaning, which includes a set of threads for which processing hardware processes the same instruction in parallel using different input data for the different threads. SIMD groups may also be referred to as SIMT (single-instruction, multiple-thread) groups, single instruction parallel thread (SIPT), or lane-stacked threads. Various types of computer processors may include sets of pipelines configured to execute SIMD instructions. For example, graphics processors often include programmable shader cores that are configured to execute instructions for a set of related threads in a SIMD fashion. Other examples of names that may be used for a SIMD group include: a wavefront, a clique, or a warp. A SIMD group may be a part of a larger threadgroup of threads that execute the same program, which may be broken up into a number of SIMD groups (within which threads may execute in lockstep) based on the parallel processing capabilities of a computer. In some embodiments, each thread is assigned to a hardware pipeline (which may be referred to as a “lane”) that fetches operands for that thread and performs the specified operations in parallel with other pipelines for the set of threads. Note that processors may have a large number of pipelines such that multiple separate SIMD groups may also execute in parallel. In some embodiments, each thread has private operand storage, e.g., in a register file. Thus, a read of a particular register from the register file may provide the version of the register for each thread in a SIMD group.

As used herein, the term “thread” includes its well-understood meaning in the art and refers to sequence of program instructions that can be scheduled for execution independently of other threads. Multiple threads may be included in a SIMD group to execute in lock-step. Multiple threads may be included in a task or process (which may correspond to a computer program). Threads of a given task may or may not share resources such as registers and memory. Thus, context switches may or may not be performed when switching between threads of the same task.

In some embodiments, multiple programmable shader units 160 are included in a GPU. In these embodiments, global control circuitry may assign work to the different sub-portions of the GPU which may in turn assign work to shader cores to be processed by shader pipelines.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write buffer 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

As discussed above, graphics processors typically include specialized circuitry configured to perform certain graphics processing operations requested by a computing system. This may include fixed-function vertex processing circuitry, pixel processing circuitry, or texture sampling circuitry, for example. Graphics processors may also execute non-graphics compute tasks that may use GPU shader cores but may not use fixed-function graphics hardware. As one example, machine learning workloads (which may include inference, training, or both) are often assigned to GPUs because of their parallel processing capabilities. Thus, compute kernels executed by the GPU may include program instructions that specify machine learning tasks such as implementing neural network layers or other aspects of machine learning models to be executed by GPU shaders. In some scenarios, non-graphics workloads may also utilize specialized graphics circuitry, e.g., for a different purpose than originally intended.

Further, various circuitry and techniques discussed herein with reference to graphics processors may be implemented in other types of processors in other embodiments. Other types of processors may include general-purpose processors such as CPUs or machine learning or artificial intelligence accelerators with specialized parallel processing capabilities. These other types of processors may not be configured to execute graphics instructions or perform graphics operations. For example, other types of processors may not include fixed-function hardware that is included in typical GPUs. Machine learning accelerators may include specialized hardware for certain operations such as implementing neural network layers or other aspects of machine learning models. Speaking generally, there may be design tradeoffs between the memory requirements, computation capabilities, power consumption, and programmability of machine learning accelerators. Therefore, different implementations may focus on different performance goals. Developers may select from among multiple potential hardware targets for a given machine learning application, e.g., from among generic processors, GPUs, and different specialized machine learning accelerators.

In the illustrated example, graphics unit 150 includes ray intersect accelerator (RIA) 190 which may include hardware configured to perform various ray intersect operations (e.g., for traversal of a bounding volume hierarchy acceleration data structure) in response to instruction(s) executed by programmable shader 160, as described in detail below.

### Overview of Prediction-Based Cache Control

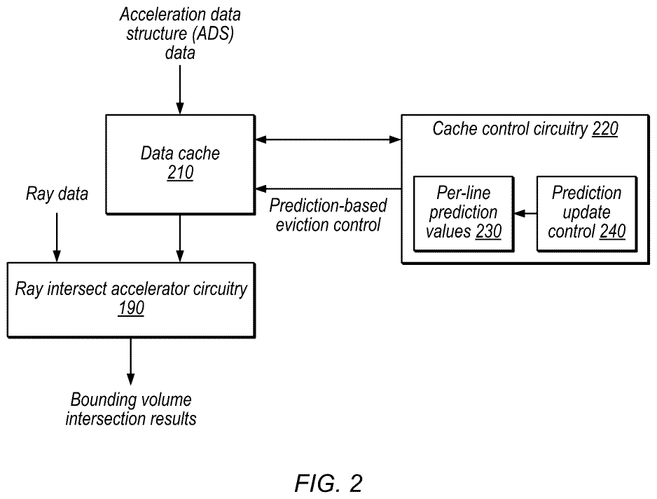

FIG. 2 is a block diagram illustrating example cache control circuitry with prediction values for a data cache, according to some embodiments. In the illustrated example, a graphics processor includes ray intersect accelerator circuitry 190, data cache 210, and cache control circuitry 220.

Ray intersection calculations are often facilitated by acceleration data structures (ADS). To efficiently implement ray intersection queries, a spatial data structure may reduce the number of ray-surface intersection tests and thereby accelerate the query process. A common class of ADS is the bounding volume hierarchy (BVH) in which surface primitives are enclosed in a hierarchy of geometric proxy volumes (e.g., boxes) that are cheaper to test for intersection. These volumes may be referred to as bounding regions. By traversing the data structure and performing proxy intersection tests along the way, the graphics processor locates a conservative set of candidate intersection primitives for a given ray. A common form of BVH uses 3D Axis-Aligned Bounding Boxes (AABB). Once constructed, an AABB BVH may be used for all ray queries, and is a viewpoint-independent structure. In some embodiments, these structures are constructed once for each distinct mesh in a scene, in the local object space or model space of that object, and rays are transformed from world-space into the local space before traversing the BVH. This may allow geometric instancing of a single mesh with many rigid transforms and material properties (analogous to instancing in rasterization). Animated geometry typically requires the data structure to be rebuilt (sometimes with a less expensive update operation known as a “refit”). For non-real-time use cases, in which millions or billions of rays are traced against a single scene in a single frame, the cost of ADS construction is fully amortized to the point of being “free.” In a real-time context, however, there is typically a delicate trade-off between build costs and traversal costs, with more efficient structures typically being more costly to build.

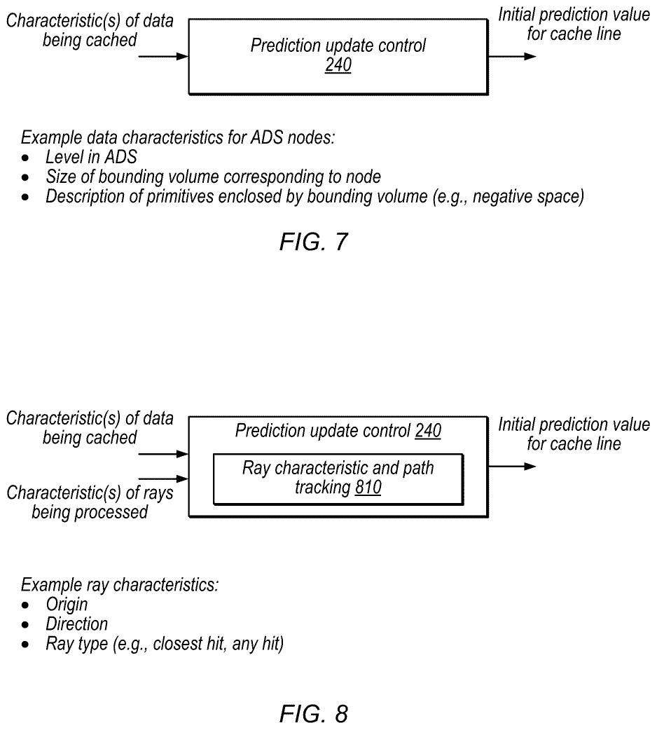

U.S. patent application Ser. No. 17/103,433 titled “Ray Intersect Circuitry with Parallel Ray Testing” and filed Nov. 24, 2020 is incorporated by reference herein and provides example node data structures for nodes of a data structure, hardware acceleration circuitry for ADS traversal, and various other ray tracing techniques that may be utilized in conjunction with the present disclosure. For example, the bounding region data cache 715 of FIG. 7 of the '433 application is one example of a data cache 210 discussed herein. Disclosed techniques may also be used with various other implementations of ray intersect acceleration hardware, however.

Data cache 210, in some embodiments, is configured to store data for an acceleration data structure, e.g., a BVH. For example, cache 210 may be a node data cache that caches node data for nodes of the BVH. As another example, cache 210 may be a primitive cache (e.g., that caches information such as vertex coordinates for triangular primitives), a transform cache (e.g., that caches transform matrices for instance transform operations), a mixed-use cache, etc. Cache 210 may be included in ray intersect circuitry 190 or located near circuitry 190 and generally may be configured to cache data such that it can be accessed by circuitry 190 in a fewer number of cycles than one or more other data caches of the graphics processor.

In some embodiments, data cache 210 is a set associative cache. For example, entries in cache 210 may be organized into multiple indices and each index may have multiple ways in a set of entries for the index. The storage circuitry for a given entry in cache 210 may be accessed using a physical address, including an index portion used to access an index, a tag portion utilized to check for hits in cache entries in the ways of the index, and an offset portion utilized to access a particular portion of a cache line, for example. In other embodiments, cache 210 may be accessed using a virtual address, e.g., corresponding to a shared or private GPU address space.

Ray intersect accelerator circuitry 190, in the illustrated example, is configured to receive ray data and ADS data cached by cache 210 generate bounding volume intersection results. In some embodiments, circuitry 190 generates a single result for a node or set of nodes based on a given command/instruction from shader 160. In other embodiments, circuitry 190 traverses multiple nodes based on a given command/instruction from shader 160. Therefore, the results may be for a node, a number of nodes, or a final result for a traversal. Further, the intersection result may indicate intersection result(s) for node(s), intersection results for primitive(s), or some combination thereof. Shader 160 may utilize the results to perform additional graphics operations (e.g., launch additional intersect commands to circuitry 190, shade primitives based on intersection results, etc.). When requested data is not available in data cache 210, the device may retrieve the data from another cache level and store the fill data in cache 210, provide the data directly to circuitry 190, or both. Therefore, misses in data cache 210 may correspond to data accesses with reduced performance, increased power consumption, or both relative to data accesses for hits in data cache 210.

Cache control circuitry 220, in some embodiments, is configured to provide prediction-based eviction control for data cache 210. Disclosed eviction control techniques may improve efficiency of data cache 210 (in terms of hit ratio, for example) relative to traditional techniques, for some processing workloads. In the illustrated example, circuitry 220 maintains per-line prediction values 230 for lines of data cache 210 and includes prediction update control circuitry 240 configured to update stored prediction values. Prediction values may be updated based on allocation of new entries, hits to entries, etc., as discussed in detail below. In some embodiments, circuitry 220 is configured to select an initial prediction value based on one or more characteristics of data being cached in a given cache line, which may further improve cache efficiency by retaining data that is more likely to be re-used.

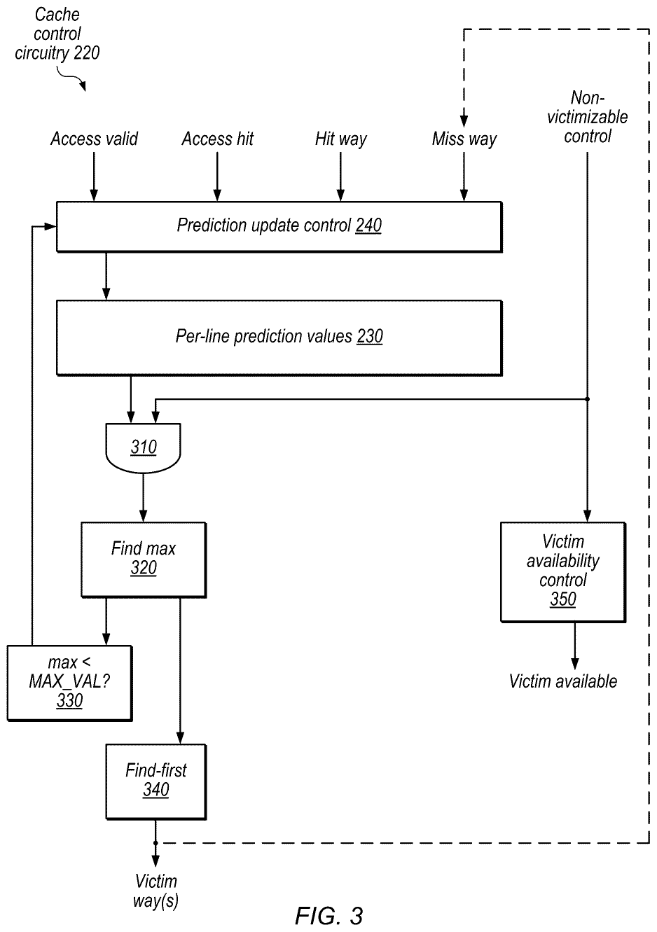

FIG. 3 is a block diagram illustrating example prediction update circuitry and victim selection circuitry, according to some embodiments. In the illustrated example, cache control circuitry 220 includes prediction update control 240, circuitry that stores per-line prediction values 230, AND logic 310, find max circuitry 320, comparison circuitry 330, find-first circuitry 340, and victim availability control circuitry 350.

Prediction update control circuitry 240, in the illustrated example, receives the following inputs: access valid, access hit, hit way, and miss way. In multi-ported embodiments, these inputs are replicated per-port and multiple victim ways may be selected in a given cycle. The access valid input indicates that there is a valid access. The access hit indicates whether or not there was a hit. The hit way indicates which way was a hit in the hit scenario, while the miss way is utilized for the miss scenario, e.g., to indicate a selected victim whose way is now available for allocation.

Generally, re-reference interval prediction (RRIP) victimization techniques utilize a re-reference prediction value (RRPV) per cache line to predict which lines are least likely to be reused in the future and therefore are the best candidate for replacement. RRIP schemes may be scalable, with different RRPV precisions used, e.g., to trade prediction accuracy against area and timing. The max supported RRPV may correspond to 2\hat{ }(number of RRPV bits)−1. In some embodiments, circuitry 220 assigns an RRPV (e.g., MAX_RRPV-1) upon initial allocation of a cache line by default. On a hit to a cache line, circuitry 240 may decrement the RRPV for that line (e.g., saturating at zero). When a new line is allocated and none of the lines in that set have an RRPV equal to MAX_RRPV, circuitry 240 may increment RRPVs for all ways within that set (saturating at MAX_RRPV). Note that the increment/decrement and max/min values discussed herein may be reversed, various number of bits may be implemented, increases/decreases by various values may be implemented, etc., in a variety of specific implementations. Various disclosed RRIP implementation details are included for purposes of explanation but are not intended to limit the scope of the present disclosure.

In multi-ported embodiments, a line may be hit in the same cycle that another line in the set is allocated, in which case the increment and decrement may cancel each other and the RRPV may remain unchanged.

Circuitry 220 may select a victim way by choosing the line with the largest RRPV within a set. Ties may be resolved using various mechanisms, e.g., using the lowest way index as a tie-breaker.

Find max circuitry 320, in some embodiments, is configured to receive the RRPVs for victimizable lines in a given set (non-victimizable techniques are discussed in detail below) and find the maximum RRPV. If the greatest value is smaller than the MAX_RRPV as determined by comparison circuitry 330, prediction update control 240 increments RRPVs as discussed above. Find-first circuitry 340 finds the first N entries having the max value (where N is the max supported number of evictions per cycle and is an integer greater than or equal to one) and outputs an indication of the selected victim way(s) corresponding to those entries. That miss way information may be utilized by prediction update control 240 to invalidate entries, assign initial RRPVs for new allocated entries, etc.

Some entries may be marked as non-victimizable, e.g., on initial allocation or based on hint information. In this information, AND logic 310 zeros out RRPVs for non-victimizable cache lines such that those lines will not be selected for eviction. In some embodiments, lines may be marked as non-victimizable for one or more cycles after they are first allocated, or for some other reason. As one specific example, in some embodiments when a line is allocated to store input data for one or more pending tests, the cache control circuitry ensures that lines are not victimized before the data is accessed to perform the test(s). Victim availability control 350 indicates whether a victim way is available in a miss scenario. For each of the supported number of potential victim outputs, circuitry 350 may generate a signal indicating whether a victim line is available.

Disclosed RRIP techniques may advantageously improve cache efficiency in the ray tracing context, relative to traditional replacement techniques (e.g., relative to least-recently-used (LRU) or pseudo-LRU techniques).

### Example Victim Selection Logic

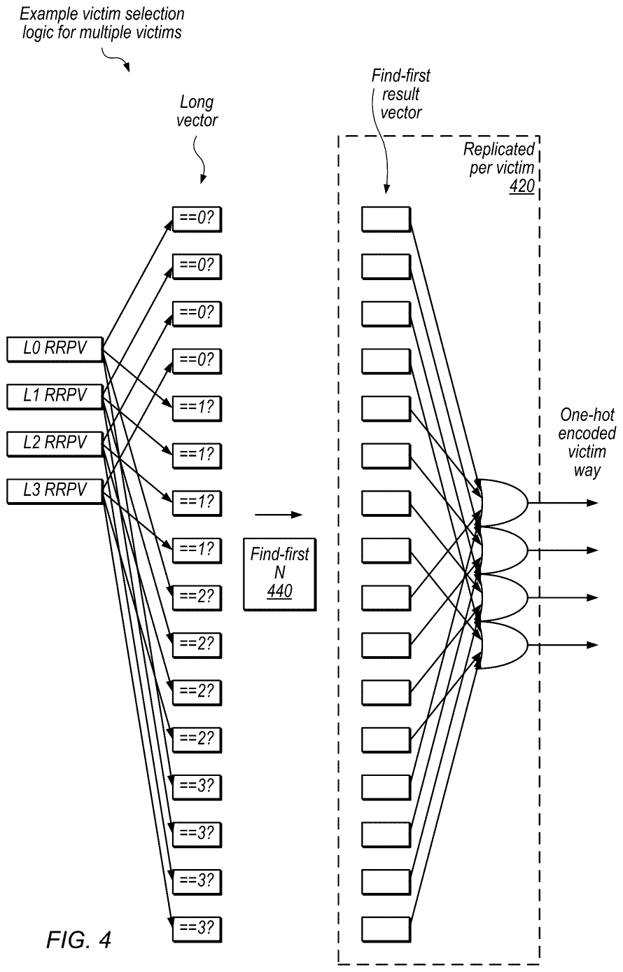

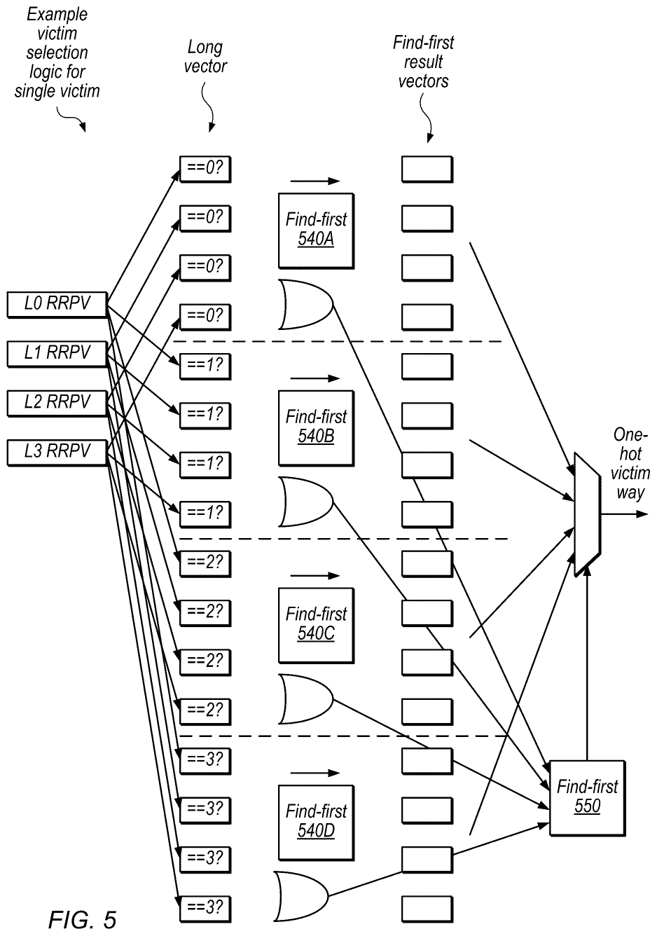

FIGS. 4-5 illustrate example logic configured to select victim ways based on prediction values (e.g., RRPVs), which may advantageously provide improved timing characteristics relative to traditional RRPV techniques, for example. These examples include different logic for single victim selection and potential selection of multiple victims.

FIG. 4 is a block diagram illustrating example victim selection logic for multiple victims that uses a long vector and a one-hot victim encoding, according to some embodiments. In this example, there are four ways/lines (L0-L3) in a given set and 2-bit RRPVs are implemented, although various other cache/RRPV configurations are contemplated.

In the illustrated embodiment, victim selection logic encodes RRPVs as a long vector that has a binary encoding of way index (0-3) and RRPV (0-3). In this example, the long vector is sixteen bits long while the way index and RRPVs are each representable using two bits.

Find-first-N logic 440, in some embodiments, is configured to find the first N set bits in the long vector, starting from the bottom/end of the vector in this example. FIG. 4. U.S. patent application Ser. No. 18/815,501 titled “Scalable Find First N Techniques,” and filed Aug. 26, 2024 provides fast, scalable examples of logic 440 that may be utilized, although various other implementations are also contemplated. The value of N may be fixed or may be specified for a given victim selection, e.g., depending on the implementation of circuitry 440. Circuitry 440 sets a bit in the find-first result vector corresponding to the first found entry in the long vector (and may generate multiple find-first result vectors with different bits set for subsequent found entries). The output logic 420 is replicated per potential victim (e.g., with N instances) and is configured to use OR logic to generate a one-hot encoding of the victim way based on a given find-first result vector.

For example, consider a scenario in which the L0 RRPV=2, the L1 RRPV=1, the L2 RRPV=2 and the L3 RRPV=3. In this example, the long vector would be 0000010010100001. The find-first result vector for the first victim would be 0000000000000001 and the one-hot victim encoding would be 0001 indicating line/way L3. The find-first result vector for a second victim would be 0000000000100000 and the one-hot victim encoding would be 0010 indicating line/way L2, and so on.

To support locked/non-victimizable lines, control circuitry may mask lines such that they do not populate entries in the long vector (e.g., using AND circuitry 310 as discussed with reference to FIG. 3 above). The victim_available signal for a given instance of logic 420 may be a single bit that is set for potential victim M if there are sufficient bits set in the long vector, for example, to provide M victims.

FIG. 5 is a block diagram illustrating example victim selection logic for a single victim that uses find-first operations among portions of the long vector, according to some embodiments. In this example, the victim selection logic encodes the RRPVs as a long vector similar to the circuitry of FIG. 4. This logic provides improved performance in the context of a single victim by finding the first way within entries for a given RRPV in parallel (using parallel find-first circuitry 540A-540D) and selecting from among the four-bit find-first results of the different find-first circuits 540 based on a find-first among four input bits to find-first circuitry 550 (where the input bits are generated by an OR of the four bits corresponding to each RRPV, as shown, and indicate whether any of the entries for a given RRPV were set). The selected output from the illustrated multiplexer provides a one-hot encoding of the victim way.

For example, for the scenario in which the L0 RRPV=2, the L1 RRPV=1, the L2 RRPV=2 and the L2 RRPV=3 and a single victim is to be selected, the long vector would be 0000010010100001. The portion of the long vector processed by circuitry 540D would be 0001, its find-first result would also be 0001, and circuitry 550 would control the multiplexer to select this vector to pass 0001 as the one-hot encoded victim way corresponding to line/way L3.

Note that cache control circuitry 220 may include both the implementation of FIG. 4 and the implementation of FIG. 5, e.g., for different eviction scenarios or for different caches. In other embodiments, cache control circuitry 220 may implement only one of these two implementations, or may implement some other victim selection logic.

Note that the data cache circuitry and the circuitry of FIGS. 4 and 5 may be parameterized, e.g., such that instances with different parameters may be included on an integrated circuit or on different integrated circuits. For example, in some embodiments the number of ways (number of lines per cache set), number of ports (number of cache lookups supported in parallel), number of victims (number of independent misses that can be processed in parallel and assigned a separate victim line), the number of RRPV bits, or some combination thereof may be parameterized in this manner.

Further note that while disclosed prediction techniques and logic are discussed in the context of a data cache for ray tracing in a graphics processor, these techniques may be applied to various other caches utilized for any of various types of data and implemented in various types of processors. Disclosed GPU and ray tracing implementations are included for purposes of explanation but are not intended to limit the scope of the present disclosure.

### Example Data-Based Selection of Initial Prediction Values

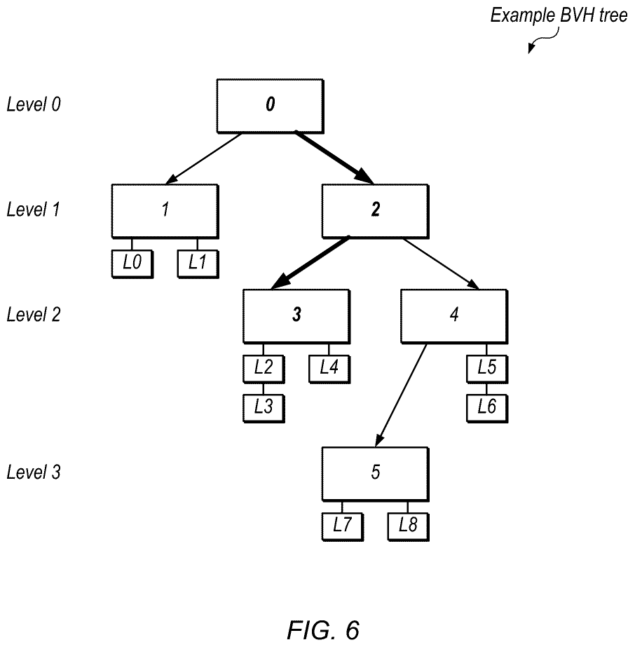

As mentioned above, cache control circuitry 220 may adjust predictions (e.g., initial RRPVs) based on characteristics of data being cached. This may advantageously provide additional increases in cache efficiency. FIG. 6 illustrates an example BVH tree with different characteristics for data that may be cached and FIG. 7 shows example prediction update control circuitry 240 configured to set initial prediction values based on these characteristics.

FIG. 6 is a diagram illustrating an example BVH tree, according to some embodiments. In embodiments in which cache 210 caches data from a BVH tree, various data characteristics may be considered when setting initial RRPVs.

The tree in the illustrated example includes four levels (level 0 through level 3) and has nodes (nodes 0 through 5) at different levels as well as leaf nodes (leaves 0 through 8) which may correspond to primitives) as children of nodes at different levels. Generally, nodes higher in the tree correspond to relatively larger bounding volumes. BVH's are typically traversed depth-first, checking for intersection with increasingly smaller bounding volumes before testing for primitives. Data from the BVH being cached may have various characteristics that are available for making retention decisions for caching, as discussed in detail below.

FIG. 7 is a block diagram illustrating example prediction update control circuitry that operates based characteristics of cached data, according to some embodiments. In the illustrated example, prediction update control circuitry 240 receives characteristic(s) of data being cached as an input and generates initial prediction values for cache lines based on this input.

As set out in FIG. 7, example data characteristics for nodes may include: level of a node in the acceleration data structure, size of the bounding volume corresponding to a node, information describing primitives enclosed by a bounding volume (e.g., information that indicates negative space within a bounding volume), or some combination thereof. Generally, nodes that are higher in the tree, with larger bounding volumes, and less negative space may be assigned larger initial RRPVs, e.g., because they are more likely to be utilized for intersection tests for other rays.

Note that data characteristics may be stored or encoded in the ADS itself or cache control circuitry may imply or generate the characteristics by analyzing the data to be cached.

For primitive data, data characteristics may include: size of primitives, orientation of primitives (relative to the screen or relative to tracked primitives, which are discussed in detail below), or a combination thereof. Generally, larger primitives and primitives that are more perpendicular may be assigned relatively larger initial RRPVs.

For transform data, data characteristics may include level in the ADS, information about magnitude of the transform (which may be derived from a transform matrix being cached), etc.

### Example Selection of Initial Prediction Values Based on Dynamic Tracking

Cache control circuitry 220 may also adjust prediction dynamically based on tracking traversal paths, alone or in combination with adjustments based on characteristics of cached data. This may advantageously provide additional increases in cache efficiency.

FIG. 8 is a block diagram illustrating example prediction update control circuitry with ray characteristic and path tracking for dynamic predictions, according to some embodiments. In the illustrated example, prediction update control circuitry 240 is configured to generate initial prediction values (e.g., RRPVs) based on both characteristics of data being cached and characteristics of rays being processed. Therefore, the strategy for assigning initial RRPV values may vary dynamically, in this embodiment, depending on the characteristics of the rays currently being processed.

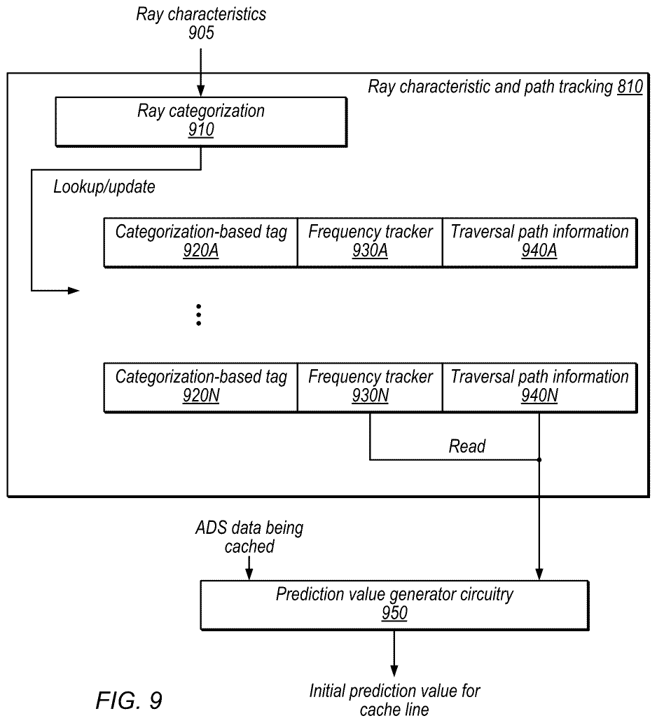

In this example, circuitry 240 includes ray characteristic and path tracking circuitry 810, detailed examples of which are discussed below with reference to FIG. 9. As set out in FIG. 8, example ray characteristics that may be tracked include: ray origin, ray direction, and ray type (e.g., whether a ray is a closest-hit ray, an any-hit ray, etc.). In other embodiments, other ray characteristics may be utilized.

Generally, circuitry 810 may track characteristics of rays that are executing (e.g., by grouping rays into bins and counting the number of rays in each bin) and may also track paths that categories of rays take through the ADS. Circuitry 810 may then increase the retention of BVH data on the frequently-traversed paths for the types of rays that are currently executing (e.g., by increasing initial RRPVs for that data relative to other data). When the types of rays being processed changes, circuitry 810 may switch to prioritizing retention of BVH data on other paths.

FIG. 9 is a block diagram illustrating a detailed example of circuitry for ray characteristic and path tracking, according to some embodiments. In this example, circuitry 810 includes ray categorization circuitry 910 and implements a table with the following fields: categorization-based tag 920, frequency tracker 930, and traversal path information 940. Prediction value generator circuitry 950 is configured to generate initial prediction values (e.g., RRPVs) based on information from the table and based on ADS data being cached.

For example, categorization-based tag 920A may correspond to rays within a certain range from an origin, that meet a threshold similarity in their directions, and are any-hit rays. Field 930A may track the frequency of rays in that group (e.g., what fraction of rays processed by circuitry 190 over a time interval are in that group). Traversal path information 940A may indicate the ADS path traveled by that group of rays (e.g., by encoding the most-common path for that group of rays, all nodes touched by that group of rays, all nodes touched a threshold number of times by that group of rays, etc.).

Circuitry 950 may then read the frequency tracker information for various groups of rays and select one or more groups of rays as inputs to prediction (e.g., the most-common category of rays currently being processed, multiple categories of rays that meet a threshold fraction of rays being processed, etc.). Circuitry 950 may read the traversal path information for those rays and match the traversal path information to the ADS data being cached. Circuitry 950 may then prioritize retention of ADS data that falls on the traversal path(s) indicated by the traversal path information, e.g., by assigning those lines lower initial RRPVs.

For example, referring back to FIG. 6, the bold arrows show a potential traversal path from node 0 through node 2 to node 3. If a category of rays was tracked to typically take this path and that category of rays currently makes up a substantial portion of the rays currently being processed, circuitry 950 may utilize lower initial RRPVs for data from nodes 0, 2, and 3 than for other nodes of the tree of FIG. 6.

### Example Method

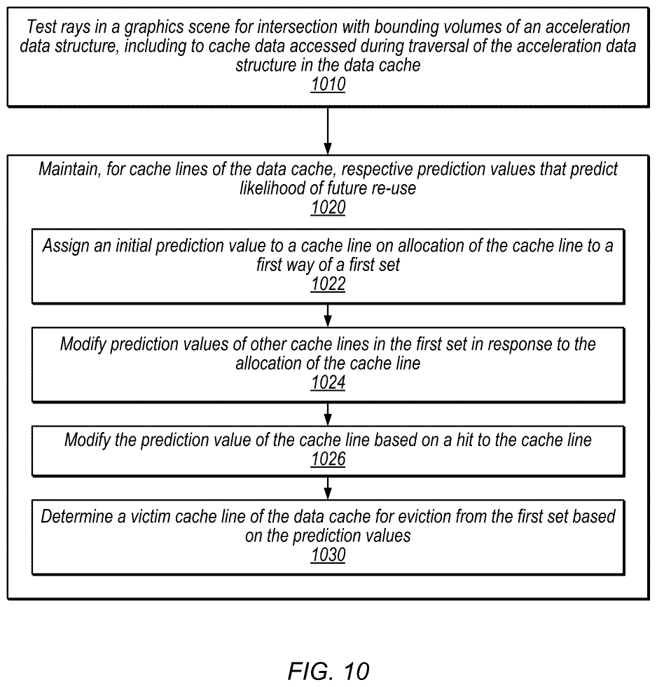

FIG. 10 is a flow diagram illustrating an example method, according to some embodiments. The method shown in FIG. 10 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1010, in the illustrated embodiment, ray intersection circuitry tests rays in a graphics scene for intersection with bounding volumes of an acceleration data structure, including to cache data accessed during traversal of the acceleration data structure in the data cache. In some embodiments, the data cache is configured to store at least one data category from the following data categories: node data for nodes of the acceleration data structure, primitive data corresponding to leaf nodes of the acceleration data structure, and instance transform data for one or more instances nodes of the acceleration data structure.

At 1020, in the illustrated embodiment, cache control circuitry maintains, for cache lines of the data cache, respective prediction values that predict likelihood of future re-use. This includes elements 1022, 1024, and 1026, in this example.

At 1022, in the illustrated embodiment, the cache control circuitry assigns an initial prediction value to a cache line on allocation of the cache line to a first way of a first set.

At 1024, in the illustrated embodiment, the cache control circuitry modifies prediction values of other cache lines in the first set in response to the allocation of the cache line. For example, the cache control circuitry may increment RRPVs of other RRPVs in the set, potentially conditioned on a check that none of the RRPVs are already at the supported max RRPV value.

At 1026, in the illustrated embodiment, the cache control circuitry modifies the prediction value of the cache line based on a hit to the cache line. For example, the cache control circuitry may decrement the RRPV for that line.

At 1030, in the illustrated embodiment, the cache control circuitry determines a victim cache line of the data cache for eviction from the first set based on the prediction values.

In some embodiments, the control circuitry is configured to assign an initial prediction value to the cache line based on one or more characteristics of data stored by the cache line. For example, the one or more characteristics may include: a level at which the data is included in the acceleration data structure, a size of one or more bounding volumes, of the acceleration data structure, encoded by the data, characteristics of one or more primitives enclosed by a bounding volume of the acceleration data structure, wherein the bounding volume is encoded in the data, or some combination thereof.

In some embodiments, the cache control circuitry is configured to assign an initial prediction value to the cache line based on characteristics of one or more rays for which the traversal of the acceleration data structure is performed. The characteristics of the one or more rays may include: ray origin, ray direction, and ray test intersection type, for example, (or some combination thereof). The cache control circuitry may also track traversal paths of rays with different characteristics through the acceleration data structure and assign the initial prediction value to the cache line based on frequency of rays having similar characteristics and tracked traversal paths of rays having similar characteristics. For example, node data corresponding to paths that have been traversed by similar rays in the paths may be prioritized for retention.

In some embodiments, the cache control circuitry is configured to select a number of victim cache lines from the first set in a given clock cycle based on the prediction values of cache lines in the first set, where the number of victim cache lines is greater than one. In these embodiments, to select the number of victim cache lines, the cache control circuitry may encode per-cache-line prediction values as a vector having a number of bits greater than the number of ways in the first set, where the vector is ordered by prediction value and includes bits that indicate the prediction value of caches lines from the first set. The cache control circuitry may then perform a find-first-N operation across the vector, where N corresponds to the number of victim cache lines. The cache control circuitry may generate, for a given victim of the victim cache lines based on the vector, a shorter, one-hot encoded vector that indicates a way of the victim cache line in the first set.

The cache control circuitry may prevent the eviction of cache lines in the data cache indicated as non-victimizable. For example, the cache control circuitry may mask non-victimizable lines such that those lines do not populate the vector.

The cache control circuitry may also include single-victim control circuitry configured to select a single victim cache line from the first set in a given clock cycle based on the prediction values of cache lines in the first set. For example, the single-victim control circuitry may encode per-cache-line prediction values as a vector having a number of bits greater than the number of ways in the first set, wherein the vector is ordered by prediction value and includes bits that indicate the prediction value of caches lines from the first set, perform a first find-first operation among entries in the vector corresponding to the same prediction value. At least partially in parallel with the first find-first operation, the single-victim control circuitry may perform a second find-first operation across the vector and may then combine results of the first find-first operation and the second find-first operation to select the single victim cache line.

### Example Device

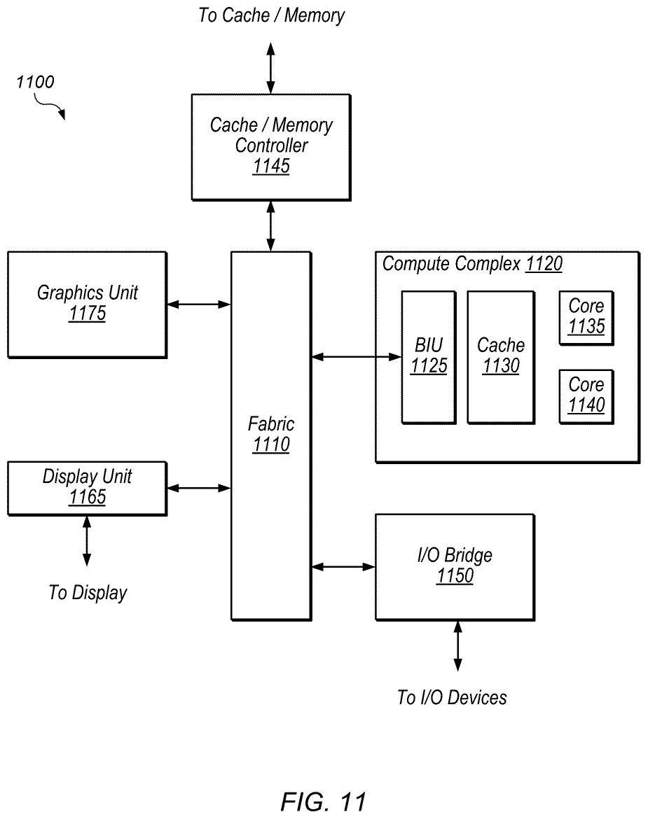

Referring now to FIG. 11, a block diagram illustrating an example embodiment of a device 1100 is shown. In some embodiments, elements of device 1100 may be included within a system on a chip. In some embodiments, device 1100 may be included in a mobile device, which may be battery-powered. Therefore, power consumption by device 1100 may be an important design consideration. In the illustrated embodiment, device 1100 includes fabric 1110, compute complex 1120 input/output (I/O) bridge 1150, cache/memory controller 1145, graphics unit 1175, and display unit 1165. In some embodiments, device 1100 may include other components (not shown) in addition to or in place of the illustrated components, such as video processor encoders and decoders, image processing or recognition elements, computer vision elements, etc.

Fabric 1110 may include various interconnects, buses, MUX's, controllers, etc., and may be configured to facilitate communication between various elements of device 1100. In some embodiments, portions of fabric 1110 may be configured to implement various different communication protocols. In other embodiments, fabric 1110 may implement a single communication protocol and elements coupled to fabric 1110 may convert from the single communication protocol to other communication protocols internally.

In the illustrated embodiment, compute complex 1120 includes bus interface unit (BIU) 1125, cache 1130, and cores 1135 and 1140. In various embodiments, compute complex 1120 may include various numbers of processors, processor cores and caches. For example, compute complex 1120 may include 1, 2, or 4 processor cores, or any other suitable number. In one embodiment, cache 1130 is a set associative L2 cache. In some embodiments, cores 1135 and 1140 may include internal instruction and data caches. In some embodiments, a coherency unit (not shown) in fabric 1110, cache 1130, or elsewhere in device 1100 may be configured to maintain coherency between various caches of device 1100. BIU 1125 may be configured to manage communication between compute complex 1120 and other elements of device 1100. Processor cores such as cores 1135 and 1140 may be configured to execute instructions of a particular instruction set architecture (ISA) which may include operating system instructions and user application instructions. These instructions may be stored in computer readable medium such as a memory coupled to memory controller 1145 discussed below.

As used herein, the term “coupled to” may indicate one or more connections between elements, and a coupling may include intervening elements. For example, in FIG. 11, graphics unit 1175 may be described as “coupled to” a memory through fabric 1110 and cache/memory controller 1145. In contrast, in the illustrated embodiment of FIG. 11, graphics unit 1175 is “directly coupled” to fabric 1110 because there are no intervening elements.

Cache/memory controller 1145 may be configured to manage transfer of data between fabric 1110 and one or more caches and memories. For example, cache/memory controller 1145 may be coupled to an L3 cache, which may in turn be coupled to a system memory. In other embodiments, cache/memory controller 1145 may be directly coupled to a memory. In some embodiments, cache/memory controller 1145 may include one or more internal caches. Memory coupled to controller 1145 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 1145 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1120 to cause the computing device to perform functionality described herein.

Graphics unit 1175 may include one or more processors, e.g., one or more graphics processing units (GPUs). Graphics unit 1175 may receive graphics-oriented instructions, such as VULKAN®, Metal®, or DIRECTX® instructions, for example. Graphics unit 1175 may execute specialized GPU instructions or perform other operations based on the received graphics-oriented instructions. Graphics unit 1175 may generally be configured to process large blocks of data in parallel and may build images in a frame buffer for output to a display, which may be included in the device or may be a separate device. Graphics unit 1175 may include transform, lighting, triangle, and rendering engines in one or more graphics processing pipelines. Graphics unit 1175 may output pixel information for display images. Graphics unit 1175, in various embodiments, may include programmable shader circuitry which may include highly parallel execution cores configured to execute graphics programs, which may include pixel tasks, vertex tasks, and compute tasks (which may or may not be graphics-related).

In some embodiments, disclosed techniques may advantageously improve graphical fidelity or images produced by graphics unit 1175, improve performance of graphics unit 1175 for a given workload, reduce power consumption of graphics unit 1175, or some combination thereof.

Display unit 1165 may be configured to read data from a frame buffer and provide a stream of pixel values for display. Display unit 1165 may be configured as a display pipeline in some embodiments. Additionally, display unit 1165 may be configured to blend multiple frames to produce an output frame. Further, display unit 1165 may include one or more interfaces (e.g., MIPI® or embedded display port (eDP)) for coupling to a user display (e.g., a touchscreen or an external display).

I/O bridge 1150 may include various elements configured to implement: universal serial bus (USB) communications, security, audio, and low-power always-on functionality, for example. I/O bridge 1150 may also include interfaces such as pulse-width modulation (PWM), general-purpose input/output (GPIO), serial peripheral interface (SPI), and inter-integrated circuit (I2C), for example. Various types of peripherals and devices may be coupled to device 1100 via I/O bridge 1150.

In some embodiments, device 1100 includes network interface circuitry (not explicitly shown), which may be connected to fabric 1110 or I/O bridge 1150. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1100 with connectivity to various types of other devices and networks.

### Example Applications

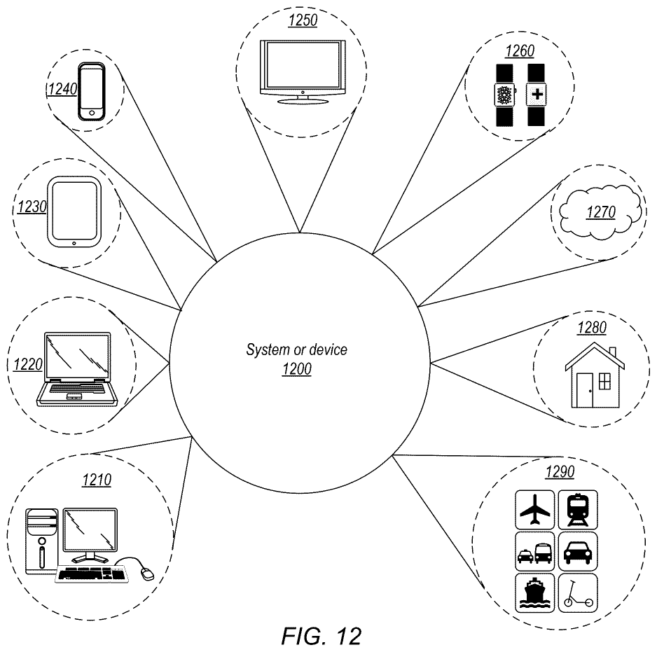

Turning now to FIG. 12, various types of systems that may include any of the circuits, devices, or system discussed above. System or device 1200, which may incorporate or otherwise utilize one or more of the techniques described herein, may be utilized in a wide range of areas. For example, system or device 1200 may be utilized as part of the hardware of systems such as a desktop computer 1210, laptop computer 1220, tablet computer 1230, cellular or mobile phone 1240, or television 1250 (or set-top box coupled to a television).

Similarly, disclosed elements may be utilized in a wearable device 1260, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1200 may also be used in various other contexts. For example, system or device 1200 may be utilized in the context of a server computer system, such as a dedicated server or on shared hardware that implements a cloud-based service 1270. Still further, system or device 1200 may be implemented in a wide range of specialized everyday devices, including devices 1280 commonly found in the home such as refrigerators, thermostats, security cameras, etc. The interconnection of such devices is often referred to as the “Internet of Things” (IoT). Elements may also be implemented in various modes of transportation. For example, system or device 1200 could be employed in the control systems, guidance systems, entertainment systems, etc. of various types of vehicles 1290.

The applications illustrated in FIG. 12 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

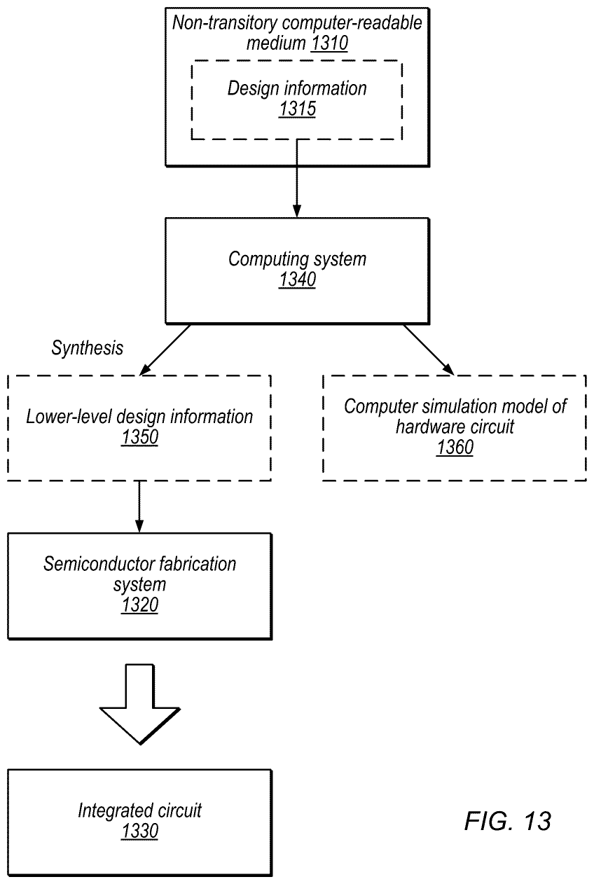

FIG. 13 is a block diagram illustrating an example non-transitory computer-readable storage medium that stores circuit design information, according to some embodiments. In the illustrated embodiment, computing system 1340 is configured to process the design information. This may include executing instructions included in the design information, interpreting instructions included in the design information, compiling, transforming, or otherwise updating the design information, etc. Therefore, the design information controls computing system 1340 (e.g., by programming computing system 1340) to perform various operations discussed below, in some embodiments.

In the illustrated example, computing system 1340 processes the design information to generate both a computer simulation model of a hardware circuit 1360 and lower-level design information 1350. In other embodiments, computing system 1340 may generate only one of these outputs, may generate other outputs based on the design information, or both. Regarding the computing simulation, computing system 1340 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 1340 also processes the design information to generate lower-level design information 1350 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 1350 (potentially among other inputs), semiconductor fabrication system 1320 is configured to fabricate an integrated circuit 1330 (which may correspond to functionality of the simulation model 1360). Note that computing system 1340 may generate different simulation models based on design information at various levels of description, including information 1350, 1315, and so on. The data representing design information 1350 and model 1360 may be stored on medium 1310 or on one or more other media.

In some embodiments, the lower-level design information 1350 controls (e.g., programs) the semiconductor fabrication system 1320 to fabricate the integrated circuit 1330. Thus, when processed by the fabrication system, the design information may program the fabrication system to fabricate a circuit that includes various circuitry disclosed herein.

Non-transitory computer-readable storage medium 1310, may comprise any of various appropriate types of memory devices or storage devices. Non-transitory computer-readable storage medium 1310 may be an installation medium, e.g., a CD-ROM, floppy disks, or tape device; a computer system memory or random access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. Non-transitory computer-readable storage medium 1310 may include other types of non-transitory memory as well or combinations thereof. Accordingly, non-transitory computer-readable storage medium 1310 may include two or more memory media; such media may reside in different locations—for example, in different computer systems that are connected over a network.

Design information 1315 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1340, semiconductor fabrication system 1320, or both. In some embodiments, design information may also include one or more cell libraries that specify the synthesis, layout, or both of integrated circuit 1330. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1330 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1320 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1320 may also be configured to perform various testing of fabricated circuits for correct operation.

In various embodiments, integrated circuit 1330 and model 1360 are configured to operate according to a circuit design specified by design information 1315, which may include performing any of the functionality described herein. For example, integrated circuit 1330 may include any of various elements shown in FIGS. 1B, 2-5, 7-9, and 11. Further, integrated circuit 1330 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 1320 to fabricate integrated circuit 1330.

The various techniques described herein may be performed by one or more computer programs. The term “program” is to be construed broadly to cover a sequence of instructions in a programming language that a computing device can execute. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of ... w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of ... w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks] —is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

1. An apparatus, comprising:
a set-associative data cache;
circuitry configured to test rays in a graphics scene for intersection with bounding volumes of an acceleration data structure, including to cache data accessed during traversal of the acceleration data structure in the data cache; and
cache control circuitry configured to:
maintain, for cache lines of the data cache, respective prediction values that predict likelihood of future re-use, including to:
assign an initial prediction value to a first cache line on allocation of the first cache line to a first way of a first set of the data cache;
modify prediction values of other cache lines in the first set in response to the allocation of the first cache line; and
modify the prediction value of the first cache line based on a hit to the first cache line; and
determine a victim cache line of the data cache for eviction from the first set based on the prediction values.

2. The apparatus of claim 1, wherein the cache control circuitry is configured to assign the initial prediction value to the first cache line based on one or more characteristics of data stored by the first cache line.

3. The apparatus of claim 2, wherein the one or more characteristics include:
a level at which the data is included in the acceleration data structure.

4. The apparatus of claim 2, wherein the one or more characteristics include:
a size of one or more bounding volumes, of the acceleration data structure, encoded by the data.

5. The apparatus of claim 2, wherein the one or more characteristics include:
characteristics of one or more primitives enclosed by a bounding volume of the acceleration data structure, wherein the bounding volume is encoded in the data.

6. The apparatus of claim 1, wherein the cache control circuitry is further configured to assign the initial prediction value to the first cache line based on characteristics of one or more rays for which the traversal of the acceleration data structure is performed.

7. The apparatus of claim 6, wherein:
the characteristics of the one or more rays include: ray origin, ray direction, and ray test intersection type; and
the cache control circuitry is further configured to:
track traversal paths of rays with different characteristics through the acceleration data structure; and
assign the initial prediction value to the first cache line based on frequency of rays having similar characteristics and tracked traversal paths of rays having similar characteristics.

8. The apparatus of claim 1, wherein:
the cache control circuitry is configured to select a number of victim cache lines from the first set in a given clock cycle based on the prediction values of cache lines in the first set, wherein the number of victim cache lines is greater than one.

9. The apparatus of claim 8, wherein to select the number of victim cache lines, the cache control circuitry is configured to:
encode per-cache-line prediction values as a vector having a number of bits greater than the number of ways in the first set, wherein the vector is ordered by prediction value and includes bits that indicate the prediction value of caches lines from the first set; and
perform a find-first-N operation across the vector, wherein N corresponds to the number of victim cache lines.

10. The apparatus of claim 9, wherein the cache control circuitry is further configured to:
generate, for a given victim of the victim cache lines based on the vector, a shorter, one-hot encoded vector that indicates a way of the victim cache line in the first set.

11. The apparatus of claim 9, wherein the cache control circuitry is configured to prevent eviction of cache lines in the data cache indicated as non-victimizable, including to mask non-victimizable lines such that those lines do not populate the vector.

12. The apparatus of claim 8, wherein the cache control circuitry includes single-victim control circuitry configured to select a single victim cache line from the first set in a given clock cycle based on the prediction values of cache lines in the first set, including to:
encode per-cache-line prediction values as a vector having a number of bits greater than the number of ways in the first set, wherein the vector is ordered by prediction value and includes bits that indicate the prediction value of caches lines from the first set;
perform a first find-first operation among entries in the vector corresponding to the same prediction value;
at least partially in parallel with the first find-first operation, perform a second find-first operation across the vector; and
combine results of the first find-first operation and the second find-first operation to select the single victim cache line.

13. The apparatus of claim 1, wherein the data cache is configured to store at least one data category from the following data categories:
node data for nodes of the acceleration data structure;
primitive data corresponding to leaf nodes of the acceleration data structure; and
instance transform data for one or more instances nodes of the acceleration data structure.

14. The apparatus of claim 1, wherein the apparatus is a computing device that further includes:
a central processing unit;
a display; and
network interface circuitry.

15. A method, comprising:
testing, by a computing system, rays in a graphics scene for intersection with bounding volumes of an acceleration data structure, including caching data accessed during traversal of the acceleration data structure in a set-associative data cache;
maintaining, by the computing system for cache lines of the data cache, respective prediction values that predict likelihood of future re-use, including:
assigning an initial prediction value to a first cache line on allocation of the first cache line to a first way of a first set of the data cache;
modifying prediction values of other cache lines in the first set in response to the allocation of the first cache line; and
modifying the prediction value of the first cache line based on a hit to the first cache line; and
determining, by the computing system, a victim cache line of the data cache for eviction from the first set based on the prediction values.

16. The method of claim 15, wherein the assigning includes the initial prediction value to the first cache line based on one or more characteristics of data stored by the first cache line.

17. The method of claim 16, wherein the one or more characteristics include at least one of the following characteristics:
a level at which the data is included in the acceleration data structure;
a size of one or more bounding volumes, of the acceleration data structure, encoded by the data; and
characteristics of one or more primitives enclosed by a bounding volume of the acceleration data structure, wherein the bounding volume is encoded in the data.

18. The method of claim 15, wherein the assigning is based on characteristics of one or more rays for which the traversal of the acceleration data structure is performed.

19. The method of claim 18, wherein the assigning is further based on tracking traversal paths of rays with different characteristics through the acceleration data structure.

20. A non-transitory computer-readable medium having instructions of a hardware description programming language stored thereon that, when processed by a computing system, program the computing system to generate a computer simulation model, wherein the model represents a hardware circuit that includes:
a set-associative data cache;
circuitry configured to test rays in a graphics scene for intersection with bounding volumes of an acceleration data structure, including to cache data accessed during traversal of the acceleration data structure in the data cache; and
cache control circuitry configured to:
maintain, for cache lines of the data cache, respective prediction values that predict likelihood of future re-use, including to:
assign an initial prediction value to a first cache line on allocation of the first cache line to a first way of a first set of the data cache;
modify prediction values of other cache lines in the first set in response to the allocation of the first cache line; and
modify the prediction value of the first cache line based on a hit to the first cache line; and
determine a victim cache line of the data cache for eviction from the first set based on the prediction values.
